(19) United States
(12) Patent Application Publication
(10) Pub. No.: US 2011/0297728 A1
(43) Pub. Date: Dec. 8, 2011

(54) NAILING DEPTH ADJUSTING DEVICE OF A PALM-TYPE NAIL GUN

(75) Inventors: Chia-Sheng Liang, Taipei Hsien (TW); Chu-Hsiang Tseng, Taipei Hsien (TW)

(73) Assignee: DE POAN PNEUMATIC CORP.

(21) Appl. No.: 13/013,226

(22) Filed: Jan. 25, 2011

(30) Foreign Application Priority Data
Jun. 4, 2010 (TW) 099210604

(51) Int. Cl. B25C 7/00

(52) U.S. Cl. 227/142

(57) ABSTRACT

A nailing depth adjusting device of a palm-type nail gun, installed in a containing recess, which is for the hammer rod to go through, at the bottom of the nail gun body. In side of the containing recess is provided with at least one guiding indentation and an adjusting sleeve. One end of the adjusting sleeve adjacent to the guiding indentation is slidably engaged in an outside wall of a guiding piece by threads. The guiding piece includes at least one guiding pillar slidably engaged in the guiding indentation. Users may rotate the adjusting sleeve to control the position of the guiding piece. Inside the adjusting sleeve is provided with an telescopic conduit. One end of the conduit is exposed outside of the adjusting sleeve. The conduit can touch the surface of the work piece, which causes the conduit to move until touching the guiding piece and thereby, adjust the nailing depth of the hammer rod.

### BACKGROUND

1. Technical Field

The present invention relates to a nailing depth adjusting device of a palm-type nail gun including an adjusting sleeve and a conduit installed on the nail gun. More particularly, the present invention relates to guiding unit for adjusting nail depth installed in the adjusting sleeve.

2. Related Art

A palm-type nail gun is a pneumatic tool which is suitable to be held by a palm and drives nails by high-pressure air. The bottom of the gun body of the palm-type nail gun includes an extendable conduit. When using the palm-type nail gun, a single nail is put inside the conduit and a hammer rod, which extends partially through the conduit, drives the nail into a surface of a work piece by short repeated hammering. As is known to all, the nail gun mentioned above needs to be controlled by human hand feeling to determine the nailing depth when a nail is driven into a flat, dented or raised surface of the work piece. As a result, when driving a plurality of nails with a palm-type nail gun, each nail can be driven into the surface of the work piece at different depths.

To solve this issue, a nail depth adjustment technology regarding palm-style nailing gun was disclosed in U.S. Pat. (No. 7,316,342). A plurality of different positioned ladder-type limiting ends is installed between a gun body and a conduit. By using the adjusting sleeve telescoping outside of the conduit, choose a limiting end of a particular height and use the limiting end to limit the movement of the conduit in order to control the nailing depth of the palm-type nail gun. The problem is that the nails in the market which are suitable to the palm-style nailing gun have different size in their length and have different required nailing depth even if they have the same size in their length. However, the height of the limiting end is predetermine and therefore, when users find there is error regarding the nailing depth, they are not able to adjust the nailing depth again in details, which causes the accuracy of the controlling of the nailing depth by ladder-type limiting ends not able to be advanced.

Furthermore, traditional nailing depth adjusting technology of the pneumatic nailing gun has been used for many years and disclosed in patents such as U.S. Pat. Nos. 5,219,110, 5,601,387 or 6,695,192. However, in U.S. Pat. No. 5,219,110, though the number of ladder-type limiting ends were increased, a large amount of micro depth between each limiting end cannot be adjusted. In addition, because the limiting ends are exposed outside of the gun body, they can easily be attractive to dust. U.S. Pat. Nos. 5,601,387 and 6,695,192 disclosed an adjusting sleeve with threads to adjust the nailing depth. However, because the adjusting sleeve directly touches the surface of the work piece, during the nailing process, the threads of the adjusting sleeve may become loose under the vibration. As a result, the nailing depth is effect and this kind of technology need to be improved.

### BRIEF SUMMARY

One purpose of the present application is to solve the issues regarding the difficulty of the adjustment of the micro depth by the nailing depth adjusting device, lost of accuracy of the nailing depth adjusting device due to the vibration, the easiness for the exposed threads to attract dust and etc.

The present application provides a nailing depth adjusting device of a palm-type nail gun, comprising:

a hammer rod including a predetermined nailing distance, being slidably engaged in a gun body of the nail gun to do a reciprocating movement driven by a high-pressure air;

an end base provided in one end of said gun body, inside of the end base being dented to form a containing recess, inside of the containing recess being provided with a center opening for the hammer rod to go through during the reciprocating movement, a recess wall of the containing recess being dented to form at least one independent guiding indentation adjacent to the center opening, inside of the guiding indentation being provided with an indentation channel in a same direction with the reciprocating movement of the hammer rod;

a lock ring being secured to a bottom of the end base;

an adjusting sleeve, rotating in situ by the limitation of the lock ring, one end of the adjusting sleeve being pivotally installed inside of the containing recess, the other end of the adjusting sleeve being exposed outside of the gun body, a sleeve opening being provided between the two ends of the adjusting sleeve for the hammer rod to go through, inside wall of the sleeve opening adjacent to the guiding indentation being provided with internal threads;

a guiding piece movable in the direction of the movement of the hammer rod, outside of the guiding piece being provided with external threads mated with internal threads to connect the guiding piece to the adjusting sleeve, one end of the guiding piece being provided with at least one independent guiding pillar, the guiding pillar being slidably engaged in the indentation channel, the other end of the guiding piece being provided with a flat limiting end, an aperture being provided between the two ends of the guiding piece for the hammer rod to go through, the position of the limiting end being controlled by rotating the adjusting sleeve; and

a conduit being slidably engaged in the sleeve opening and being pushed by an elastic force, the conduit being provided for the hammer rod to go through, the conduit including a flat pushing end concealed in the sleeve opening and a shooting end exposed outside of the adjusting sleeve.

When the adjusting sleeve is rotated, internal threads may rotate towards the external threads. Because the guiding pillar may be limited by the indentation channel of the guiding indentation, the guiding piece may be prevented from rotating with the adjusting sleeve, which causes the guiding piece to move in the direction of the movement of the hammer rod and thereby adjust the position of the limiting end; The shooting end can push and touch the surface of the work piece, which causes the pushing unit to move until touching the limiting end and therefore, the depth for the hummer lever to drive towards the nail may be controlled.

The limiting end and the pushing end may be concealed inside of the gun body, which can prevent from the dust in outside circumstances. In addition, the limiting end may move linearly in the direction of the movement of the hammer rod in order to be closer or farther to the pushing end. As a result, the distance between the limiting end and pushing end can be precisely controlled and therefore, the accuracy to control the nailing depth may be increased. Furthermore, the adjusting sleeve can be in charge of adjusting the height of the guiding piece, which may prevent adjusting sleeve from directly touching the work piece and therefore, may help to control the nailing depth.

The application also discloses:

The guiding indentations are arranged at equal intervals around the center opening.

The other end of the adjusting sleeve is exposed outside of the gun body to form a rotation unit.

On the inside wall of the sleeve opening adjacent to the rotation unit is provided with a neck opening preventing the conduit from separation from the adjusting sleeve.

Inside the sleeve opening is provided with a spring between the guiding piece and the conduit to push the conduit.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an exploded prospective view of one embodiment of the present invention.

FIG. 2 is an exploded sectional view of one embodiment of the present invention.

FIG.3 is an assembled sectional view of one embodiment of the present invention.

FIG. 4 is a partial amplified sectional view of FIG.3.

FIG. 5 is a schematic illustration showing the inside arrangement of one embodiment of the containing recess.

FIG. 6 is an action state diagram of FIG.3.

FIG. 7 is an action state diagram of FIG.4.

FIG. 8 is an action state diagram of FIG.6.

FIG. 9 is an action state diagram of FIG.4.

FIG. 10 is an action state diagram of FIG.6.

### DETAILED DESCRIPTION

Hereinafter, the present invention will be described in detail with reference to the accompanying drawings. It should be understood that drawings do not limit the scope of the present invention.

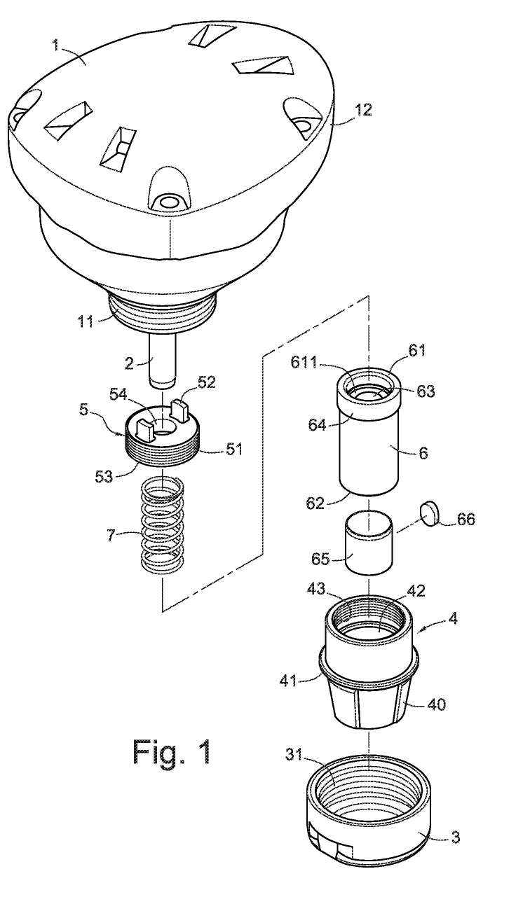

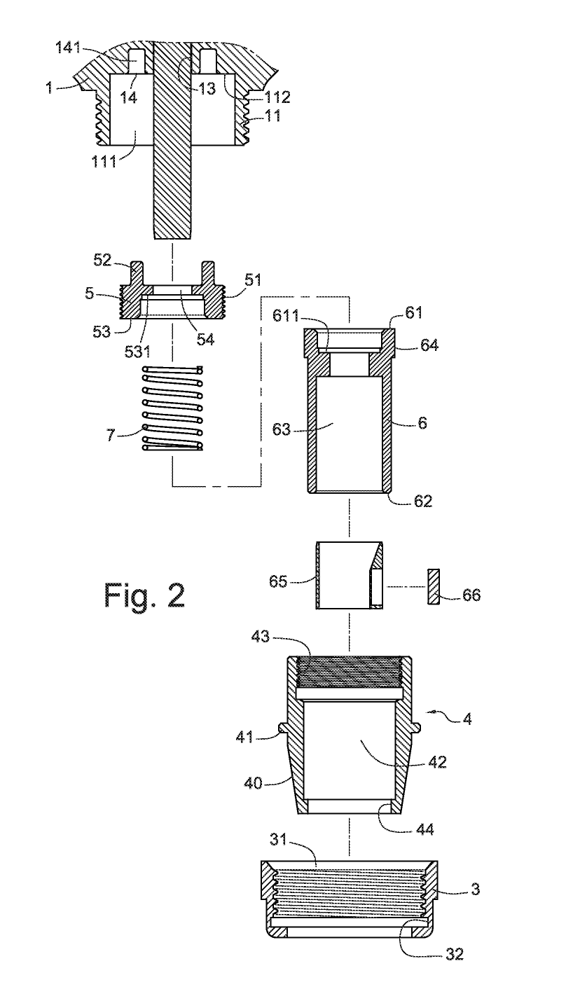

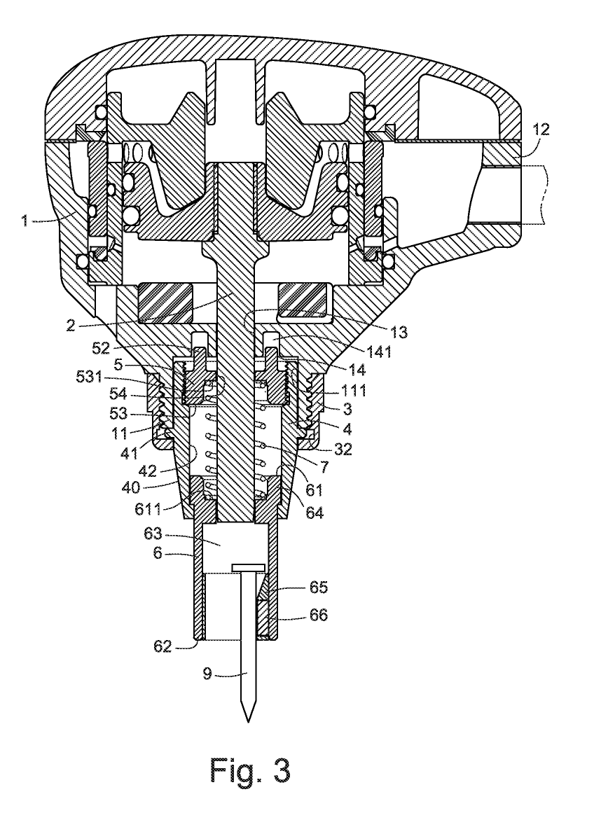

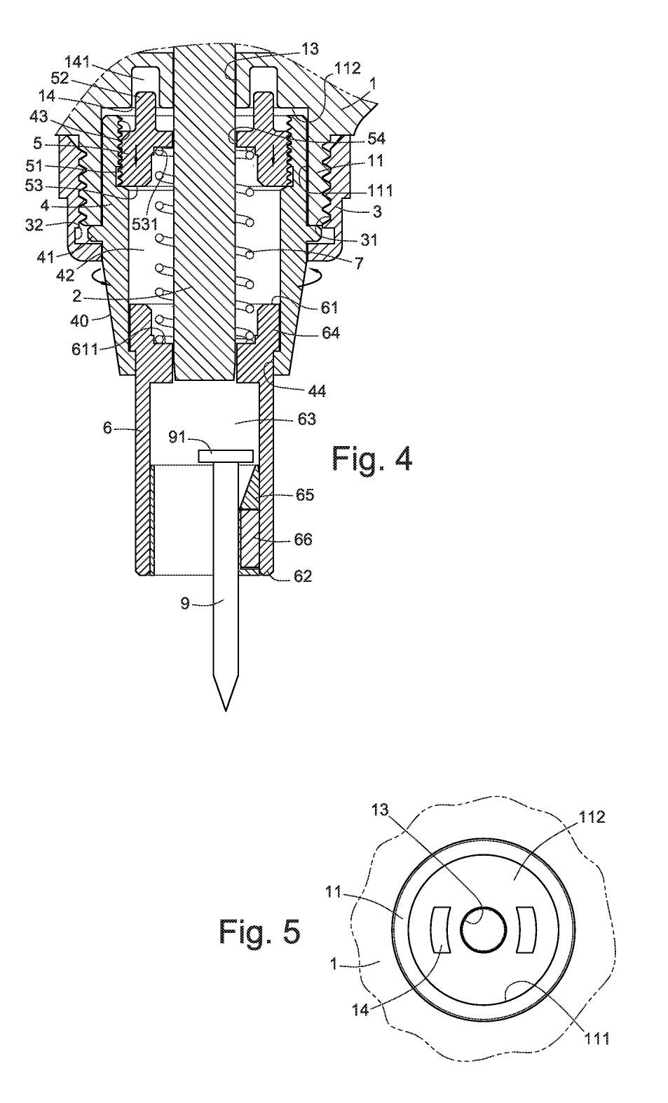

FIG. 1 is an exploded prospective view of one embodiment of the present invention. As shown in FIG. 1 accompanying with FIG. 2, FIG. 3 and FIG. 4, a nailing depth adjusting device of a palm-type nail gun may comprise a hammer rod 2 including a predetermined nailing distance, an end base 11, a lock ring 3, an adjusting sleeve 4, a guiding piece 5 movable in the direction of the movement of the hammer rod 2, and a conduit 6. The hammer rod 2 may be slidably engaged in a gun body 1 of the nail gun. The gun body 1 may have a shape which can be held by the hand. A gas inlet 12 may be provided on one side of the gun body 1 to let outside high-pressure air into the gun body 1 to drive the hammer rod 2 to do a reciprocating movement in its direction. The end base 11 may have a round shape, protruding from the bottom of the gun body 1 to be an end thereof. The inside of the end base 11 may be dented to form a round containing recess 111. A top recess wall 112 of the containing recess 111 may be provided with a vertical center opening 13 for the hammer rod 2 to go through in its reciprocating movement. The top recess wall 112 of the containing recess 111 adjacent to the center opening 13 may be dented to form at least one independent rectangle guiding indentation 14 (shown in FIG. 5). The guiding indentation 14 may form a vertical indentation channel 141 in the same direction with the reciprocating movement of the hammer rod 2. The guiding indentation 14 may be arranged at equal intervals around the center opening 13. The present embodiment may have two guiding indentations 14 on each side of the center opening 13.

The lock ring 3 may be a cylindrical sleeve (see FIG. 1 to FIG. 4) and may form a vertical central aperture 31 to connect the top and bottom of the lock ring 3. The lock ring 3 may be secured to the bottom of the end base 11 by threads of the central aperture 31. The central aperture 31 may be connected to the containing recess 111. The bottom of the lock ring 3 may be extended below the outside portion of the containing recess 111. A round slot 32 may be formed between the internal wall of the central aperture 31 of the bottom of lock ring 3 and the bottom of end base 11. In one embodiment, the adjusting sleeve 4 may rotate in situ because of the limitation of the lock ring 3. The adjusting sleeve 4 has a cylindrical outside wall for its upper level and a conical-shaped outside wall for its bottom level. A rib ring 41 may be formed in between. The rib ring 41 may be installed relatively pivotally inside the round slot 32. The upper level of the outside wall of the adjusting sleeve 4 may be installed pivotally inside of the containing recess 111 and the central aperture 31. The bottom level of the outside wall of the adjusting sleeve 4 may be exposed outside the end base 11 of the gun body 1 to form a conical-shaped rotating unit 40 which can be rotated by users' fingers. A sleeve opening 42 for the hammer rod 2 to go through may be created between the top and bottom end of the adjusting sleeve 4. The sleeve opening 42 may be positioned below the guiding indentation 14. The inside wall of the sleeve opening 42 adjacent to the guiding indentation 14 may include internal threads 43. The inside wall of the sleeve opening 42 adjacent to the rotating unit 40 may include a neck opening 44.

The guiding piece 5 may have a circular shape (see FIG. 1 to FIG. 4), may be installed inside the sleeve opening 42 and be adjacent to a top recess wall 112 of the containing recess 111. The outside wall of the guiding piece 5 may include external threads 51 mated with internal threads 43 in order for the guiding piece 5 to be connected with the adjusting sleeve 4. The guiding piece 5 may include at least one independent rectangle guiding pillar 52 in the direction of the movement of the hammer rod 2 facing one end of the top recess wall 112 of the containing recess 111. In this embodiment, the guiding pillar 52 may have the same amount as the guiding indentation 14. The guiding pillar 52 may be slidably engaged in the indentation channel 141 of the guiding indentation 14. Because the indentation channel 141 may be extended in the direction of the reciprocating movement of the hammer rod 2, the guiding pillar 52 may be able to do the reciprocating movement in the direction of the movement of the hammer rod 2. The indentation channel 141 may be able to prevent the guiding pillar 52 from moving along the direction that is not the direction of the reciprocating movement of the hammer rod 2 and therefore to limit the guiding pillar 52 inside of the indentation channel 141. The other end of the guiding piece 5 may form a flat circular limiting end 53 facing downwards. Between the top and bottom end of the guiding piece 5 may be provided with an aperture 54 for the hammer rod 2 to go through.

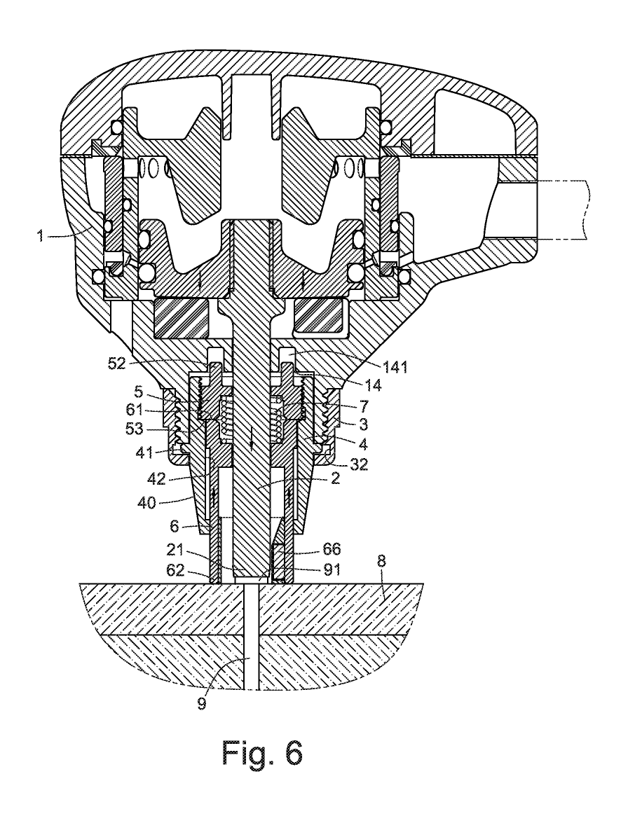

The conduit 6 may be a circular tube (see FIG. 1 to FIG. 4), being slidably engaged in the sleeve opening 42 and being pushed by an elastic force. A flat circular pushing end 61 may be formed at the top of the conduit 6 and may be slidably engaged in the sleeve opening 42. The pushing end 61 may be positioned below the limiting end 53. At the bottom of the conduit 6, a shooting end 62 may be formed to be exposed outside of the adjusting sleeve 4. A guiding aperture 63 may be formed between the pushing end 61 and the shooting end 62 for the hammer rod 2 to go through. A convex ring 64 may be formed in the upper outside wall of the conduit 6. A spring 7 may be provided inside of the sleeve opening 42 and be compressed between the limiting end 53 of the guiding piece 5 and the pushing end 61 of the conduit 6. The conduit 6 may be pushed by an elastic force and may driven the shooting end 62 to move downwards with the conduit 6 and thereby be exposed outside of the adjusting sleeve 7. The convex ring 64 may be limited by the neck opening 44 at the bottom of the sleeve opening 42, which prevents conduit 6 from separating from the adjusting sleeve 4. In fact the limiting end 53 may form a circular notch 531 surrounding the aperture 54. The pushing end 61 may form a circular notch 611 surrounding the guiding aperture 63. The spring 7 may be compressed between the circular notches 531 and 611. The shooting end 62 may be able to touch and push the work piece 8. (See FIG. 6). As a result, the conduit 6 may overcome the elastic force of the spring 7 and be indented into the adjusting sleeve 4. In addition, a cylindrical sleeve 65 for the hammer rod 2 to go through may be installed inside the guiding aperture 63. A magnetic element 66, which may be able to attract a nail 9, may be installed between the inside wall of the guiding aperture 63 and outside wall of the cylindrical sleeve 65. The magnetic element 66 may be a magnet.

The operation of the present application may be described in the following paragraphs. It is important to notice that in the present application, a quick and simple turning action may be able to achieve the purpose of slightly adjusting the nailing depth. By turning the adjusting sleeve 4, the guiding piece 5 may move linearly in the direction of the movement of the hammer rod 2 and therefore, the distance inside the sleeve opening 42 between the limiting end 53 and the pushing end 61 may be adjusted and the purpose of slightly adjusting the nailing depth may be achieved. In the following paragraphs, the action state of the palm-type nail gun may be described regarding the movement of the guiding piece 5 accompanying with the different rotation frequency and rotation direction of the adjusting sleeve 4.

When users rotate the adjusting sleeve 4 (as shown in FIG. 4), the adjusting sleeve 4 may be rotated in situ because of the limitation of the lock ring 3. The internal threads 43 of the sleeve opening 42 may be rotated accompanying with the adjusting sleeve 4. However, because the guiding pillar 52 of the guiding piece 5 may be limited inside of the indentation channel 141 of the guiding indentation 14, the guiding piece 5 may be prevented from rotating with the adjusting sleeve 4 through threads 43 and 51. As a result, internal threads 43 rotate relatively to the external threads 51, which may causes the guiding piece 5 to move downwards in the direction of the reciprocating movement of the hammer rod 2. The guiding pillar 52, which may be inside of guiding indentation 14, may move down in the direction towards the movement of the hammer rod 2 to decrease the distance between the limiting end 53 and the pushing end 61 and therefore, the distance for the conduit 6 to move upwards may also be decreased and the nailing depth may be slightly adjusted. When the palm-type nail gun, which may include a nail 9 attached to the conduit 6, may be pushed towards the surface of a work piece 8 (as shown in FIG. 6), shooting end 62 may touch and push the surface of the work piece 8 and the conduit 6 may be indented into the adjusting sleeve 4 against elastic force. As a result, the pushing end 61 may accompany the conduit 6 to move upwards until touching the limiting end 53, which may prevent the conduit 6 from moving further. Because the distance between the limiting end 53 and the pushing end 61 may be decreased and the nailing movement of the hammer rod 2 may be predetermined, the shooting end 62 after moving upwards with the conduit 6 may be still in a position lower than the position of the top end 21 of the hammer rod 2 after nailing downwards. Therefore, when a nail 9 may be driven into the surface of the work piece 8, a nail head 91 may be protruding from the surface of the work piece 8.

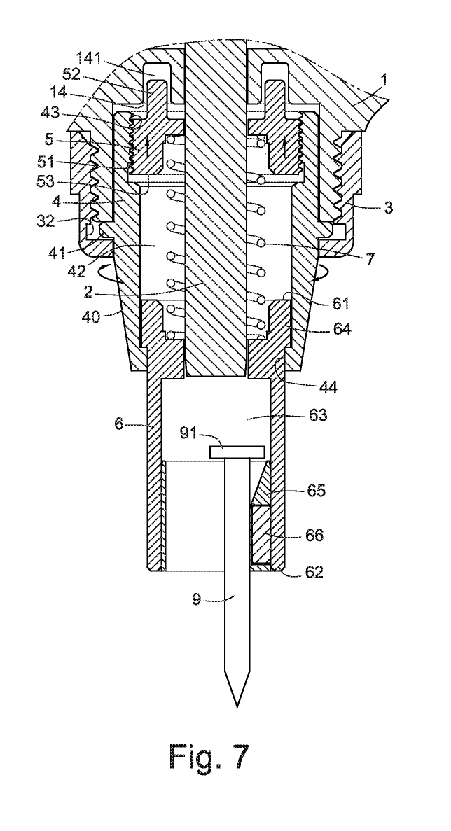

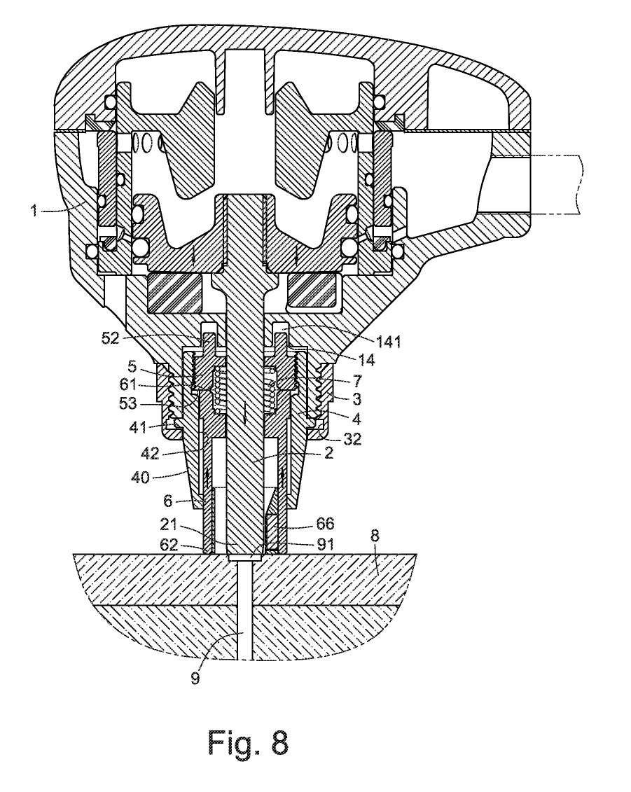

When users rotate the adjusting sleeve 4 to move the guiding piece 5 upwards in the direction of the movement of the hammer rod 2 (as shown in FIG. 7), the distance between the limiting end 53 and the pushing end 61 may be increased and the distance for the conduit 6 to move upwards may be increased. When the palm-type nail gun may be pushed towards the surface of a work piece 8 (as shown in FIG. 8), the pushing end 61 may accompany the conduit 6 to move upwards until touching the limiting end 53, which may prevent the conduit 6 from moving further. Because the distance between the limiting end 53 and the pushing end 61 may be increased, the height of the shooting end 62 after moving upwards with the conduit 6 may be equal to the height of the top end 21 of the hammer rod 2 after nailing downwards. Therefore, when a nail 9 may be driven into the surface of the work piece 8, a nail head 91 may be positioned in the same level with the surface of the work piece 8.

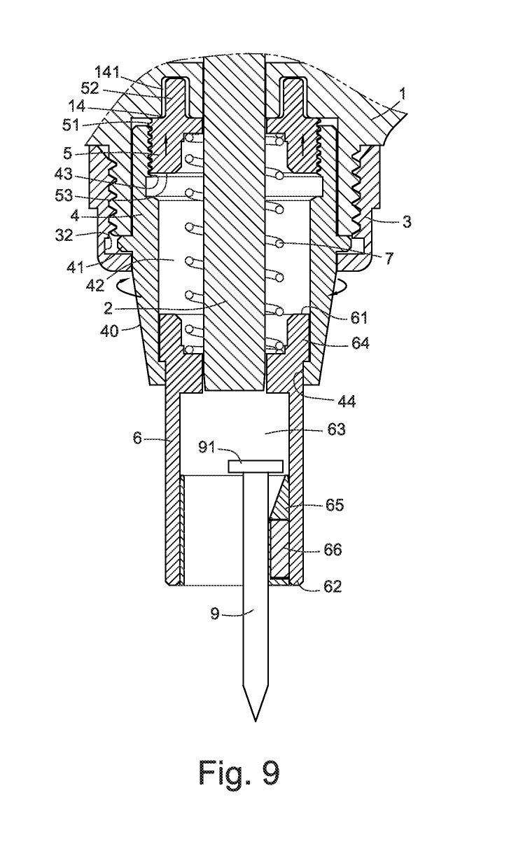

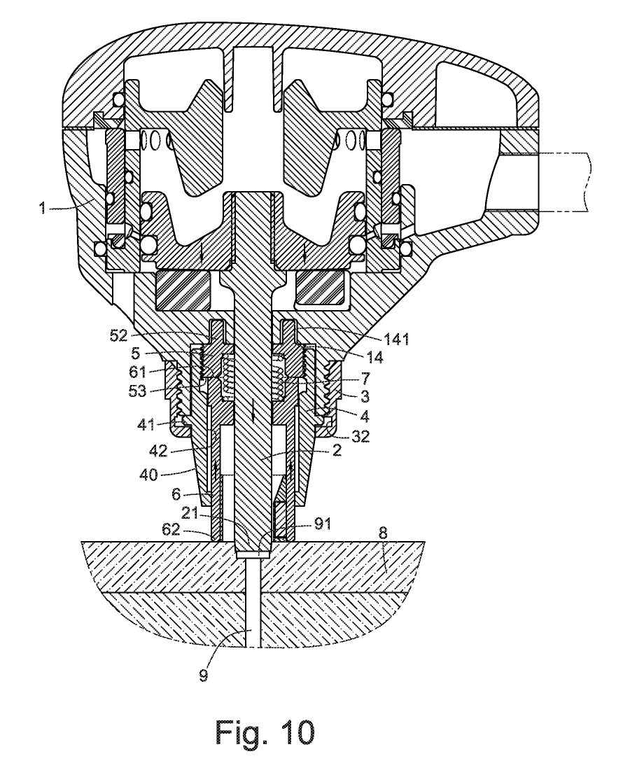

When users rotate the adjusting sleeve 4 to move again the guiding piece 5 upwards in the direction of the movement of the hammer rod 2 (as shown in FIG. 9), the distance between the limiting end 53 and the pushing end 61 may be increased more and the distance for the conduit 6 to move upwards may be increased more. When the palm-type nail gun may be pushed towards the surface of a work piece 8 (as shown in FIG. 10), the pushing end 61 may accompany the conduit 6 to move upwards until touching the limiting end 53, which may prevent the conduit 6 from moving further. Because the distance between the limiting end 53 and the pushing end 61 may be increased more, the height of the shooting end 62 after moving upwards with the conduit 6 may be higher than the height of the top end 21 of the hammer rod 2 after nailing downwards. Therefore, when a nail 9 may be driven into the surface of the work piece 8, a nail head 91 may be positioned dented into the surface of the work piece 8.

It is believed that the present application is sufficiently disclosed. When the adjusting sleeve 4 may be rotated, internal threads 43 of the adjusting sleeve 4 rotate relatively to the external threads 51 of the guiding piece 5. Because the guiding pillar 52 may be limited by the indentation channel 141 of the guiding indentation 14, the guiding piece 5 may be prevented from rotating with the adjusting sleeve 4, which causes the guiding piece 5 to move inside of the sleeve opening 42 of the adjusting sleeve 4 in the direction of the movement of the hammer rod 2 and thereby, the depth for the hummer lever 2 to drive towards the nail 9 may be controlled. The limiting end 53 and the pushing end 61 may be concealed inside of the gun body 1, which can prevent from the dust in outside circumstances. In addition, the limiting end 53 may move linearly in the direction of the movement of the hammer rod 2 in order to be closer or farther to the pushing end 61. As a result, the distance between the limiting end 53 and pushing end 61 can be precisely controlled and therefore, the accuracy to control the nailing depth may be increased. Furthermore, the adjusting sleeve 4 can be in charge of adjusting the height of the guiding piece 5, which may prevent adjusting sleeve 4 from directly touching the work piece and therefore, may help to control the nailing depth.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A nailing depth adjusting device of a palm-type nail gun, comprising:
a hammer rod including a predetermined nailing distance, being slidably engaged in a gun body of the nail gun to do a reciprocating movement driven by a high-pressure air;
an end base provided in one end of said gun body, inside of the end base being dented to form a containing recess, inside of the containing recess being provided with a center opening for the hammer rod to go through during the reciprocating movement, a recess wall of the containing recess being dented to form at least one independent guiding indentation adjacent to the center opening, inside of the guiding indentation being provided with an indentation channel in a same direction with the reciprocating movement of the hammer rod;
a lock ring being secured to a bottom of the end base;
an adjusting sleeve, rotating in situ by the limitation of the lock ring, one end of the adjusting sleeve being pivotally installed inside of the containing recess, the other end of the adjusting sleeve being exposed outside of the gun body, a sleeve opening being provided between the two ends of the adjusting sleeve for the hammer rod to go through, inside wall of the sleeve opening adjacent to the guiding indentation being provided with internal threads;
a guiding piece movable in the direction of the movement of the hammer rod, outside of the guiding piece being provided with external threads mated with internal threads to connect the guiding piece to the adjusting sleeve, one end of the guiding piece being provided with at least one independent guiding pillar, the guiding pillar being slidably engaged in the indentation channel, the other end of the guiding piece being provided with a flat limiting end, an aperture being provided between the two ends of the guiding piece for the hammer rod to go through, the position of the limiting end being control by rotating the adjusting sleeve; and
a conduit being slidably engaged in the sleeve opening and being pushed by an elastic force, the conduit being provided for the hammer rod to go through, the conduit including a flat pushing end concealed in the sleeve opening and a shooting end exposed outside of the adjusting sleeve, the shooting end being able to touch a surface of a work piece and causing the pushing end to move until touching the limiting end and thereby controlling the nailing depth of the hammer rod.

2. The nailing depth adjusting device of a palm-type nail gun according to claim 1, wherein the guiding indentations are arranged at equal intervals around the center opening.

3. The nailing depth adjusting device of a palm-type nail gun according to claim 1, wherein the other end of the adjusting sleeve is exposed outside of the gun body to form a rotation unit.

4. The nailing depth adjusting device of a palm-type nail gun according to claim 3, wherein on the inside wall of the sleeve opening adjacent to the rotation unit is provided with a neck opening preventing the conduit from separation from the adjusting sleeve.

5. The nailing depth adjusting device of a palm-type nail gun according to claim 1, wherein inside the sleeve opening is provided with a spring between the guiding piece and the conduit to push the conduit.
